(19) United States
(12) Patent Application Publication
(10) Pub. No.: US 2024/0122258 A1
(43) Pub. Date: Apr. 18, 2024

(54) An Electrically Powered Smoking Device Including an Optical Sensing System for Identifying Indicium of Smoking Articles

(71) Applicant: JT International SA, Geneva (CH)

(72) Inventor: Patrick Debergh, Cressier (CH)

(73) Assignee: JT International SA, Geneva (CH)

(21) Appl. No.: 18/278,275

(22) PCT Filed: Feb. 18, 2022
(86) PCT No.: PCT/EP2022/054072

§ 371 Date: Aug. 22, 2023

(30) Foreign Application Priority Data
Feb. 23, 2021 (EP) 21158708.4

(51) Int. Cl. A24F 40/51; A24F 40/20; A24F 40/40

(52) U.S. Cl. CPC A24F 40/51; A24F 40/20; A24F 40/40

(57) ABSTRACT

An electrically powered smoking device configured to receive a consumable article includes a housing having a cavity, defining a cavity axis, for receiving at least partially the consumable article, and an optical sensing system for detecting indicia on the consumable article, wherein the optical sensing system includes at least one pinhole and an image detector, wherein the pinhole allows to form an image on an image plane, detectable by the image detector.

### TECHNICAL FIELD OF THE INVENTION

The present invention relates to the field of tobacco, in particular to reconstituted tobacco as well as aerosol-generating article. The present invention further relates to smoking devices and/or aerosol-generating devices, especially to an electrically heated aerosol-generating system or an electrically heated e-liquid system.

### BACKGROUND OF THE INVENTION

Electronic vaping devices based on aerosol-generating consumable articles have gained popularity in the recent years. There are mainly two types: liquid vaporizing devices and heated tobacco or plant-based substrates devices. Heated tobacco devices are referred to as “heat-not-burn” (HNB) systems. They provide a more authentic tobacco flavour compared to liquid vaporizing cigarettes, which deliver an inhalable aerosol from heating of liquid compositions comprising aerosol formers, flavourant, and often nicotine. HNB systems heat a tobacco material comprising an aerosol-forming substance (such as glycerine and/or propylene glycol) which vaporises during heating and creates a vapour that extracts nicotine and flavour components from the tobacco material. The tobacco substance is usually heated at between 200 and 400° C., which is below the normal burning temperatures of a conventional cigarette. The inhaler device is typically hand-held, which may be configured to receive rod-shaped consumable articles.

Illicit trade of aerosol-generating articles, be it standard cigarettes, e-liquids, or HNB articles, is a problem, as counterfeit articles in particular may be of inferior quality or, in the case of e-liquids or HNB consumable articles, may not be suited to a determined smoking system. In order to identify whether an aerosol-generating consumable article is an authentic one a code or equivalent marking containing information about the article may be arranged on an outer surface thereof for it to be detected in use or prior use with an authentication device. In case of negative authentication, it is then possible to prevent working of the inhaler device with which it is used. So, it is desired that the indicium may also contain information of specific parameters that should be used by the inhaler devices such as the ideal temperature range, or the heating profile in function of time, or parameters which allow to provide to the smoker different smoking tastes or intensities. To provide accurate authentication of a code on a consumable article such as an HNB article, the recognition probability should be very high so that suitable articles will not be rejected.

Various attempts at providing authenticatable aerosol-generating articles have been proposed in the prior art already. For instance, US20190008206A1 discloses a smoking article comprising an indicium on an outer surface, where the indicium may be in the form of pattern that may be a one- or two-dimensional barcode. The indicium includes different grey levels that can be generated by printing in dots which have smaller size. Such indicium can be detectable and reproducible and may contain only a small density of information or should be provided with an unacceptably large size. Nevertheless, the optical sensing mechanism proposed in US20190008206A1 requires imaging lens or mirrors in order to read the indicium.

It is also known from the prior art to provide a smoking article comprising a marker arrangement or indicia indicative of a parameter associated with the article such that the marker elements extend around the circumference of the article. Furthermore, an optical sensor arrangement configured to read the indicia of the article received within the chamber of the apparatus for generating aerosol. The optical sensor may be located in a hollow tube and may be in contact with the article or may be retractable relative to the article to provide a wider field. Often, it requires a complicated sensor arrangement in order to detect the indicia on the consumables. For instance, as lenses, mirrors or sensors are provided to the image detecting system, a cover system has to be provided between the sensor and the chamber in order to prevent dust or ashes to reach and block the view of the sensor.

Imaging of indicia may be performed through lenses or mirrors; however, it is difficult to arrange them in the very small space that is available near a cavity of an inhaler device. Furthermore, there are issues related to areas in such inhaler devices where the temperature in use can be higher than 100° C. or even higher than 200° C., which limits considerably the choice of materials. Also, lenses and mirrors have to be aligned and adapted in holders and it is difficult to reduce the assembly costs. Furthermore, depending on the used materials such as transparent plastics there is an issue of the long-term stability. Also, if lenses are used, they may be scratched or damaged by cleaning brushes. The lenses may need to be cleaned regularly as ashes or particles from the consumables may obstruct its surface.

There is thus a need for simple, robust, and cheap imaging systems to allow authentication of aerosol-generating articles without overly sophisticated detecting system.

### SUMMARY OF THE INVENTION

The invention provides solutions to at least part, if not all, of the above-discussed problems by providing a smoking device comprising a novel optical sensing system, wherein the optical sensing system comprises at least one pinhole-based imaging system. The pinhole serves to allow limited light to pass and subsequently form an image on an image plane that is detectable by an image detector. Thanks to its pinhole optical sensing system, the device of the invention provides an optical solution to detect and identify information contained in an indicium or indicia arranged on or in an aerosol generating article that may comprise high density coded information or a very basic low-resolution coded information.

The invention as described herein simplifies considerably indicia recognition compared to prior art systems which typically require use of lenses and/or mirror. In other words, the present invention eliminates the need for lenses and/or mirror element. As a result, the smoking device of the invention provides an optical sensing system arranged in a constrained, narrow space, which is in turn a cheap alternative to known lenses- and/or mirrors-based optical sensing system.

Furthermore, the optical sensing system of the smoking device of the invention may be at least in part arranged in proximity or in contact with a heater of the smoking device, as the optical sensing system is not affected by the heat generated in use.

In a first aspect, the invention therefore relates to an electrically powered smoking device configured to receive a consumable article, comprising, (a) a housing having a cavity, defining a cavity axis, for receiving at least partially the consumable article; and (b) an optical sensing system for detecting indicia on the consumable article, wherein the optical sensing system comprises at least one pinhole and an image detector, wherein the pinhole allows to form an image on an image plane, detectable by the image detector.

Using a pinhole for imaging allows to provide infinite depth of field and everything that is imaged remains in focus. As there is no lens distortion, wide-angle images remain absolutely rectilinear, which is an advantageous aspect to image identification codes.

In a second aspect, the invention relates to the use of the smoking device according to the present invention for detecting indicia of a consumable article.

According to one embodiment, the optical sensing system may comprise a light source, preferably positioned close to the pinhole on a side facing the consumable article. For example, the light source may illuminate directly the indicia of the consumable article directly, or indirectly via a reflecting element being used to reflect the light of the light source towards the indicia of the consumable article. A clearer image can thus be produced.

According to another embodiment, at least two pinholes positioned opposite to each other are provided to the smoking device such that the indicia on the consumable article can be detected by the optical sensing system through the at least two pinholes. This advantageously allows more information to be detected by the optical sensing system on the indicia. Alternatively, it serves as a false-proof mechanism as two images, having the same coded information, formed on the image plane are produced from two opposite sides of the consumable article, hence the sensitivity of the optical sensing system can be increased.

According to yet another embodiment, at least two pinholes may be provided to different axial and/or longitudinal positions. For instance, when the pinholes are provided to different axial and/or longitudinal positions, the image formed on the image plane may be at least partially overlapped such that a wider image can be formed on image plane and to be detected by the image detector.

According to yet another embodiment, at least two pinholes may be provided to a same axial position or longitudinal position. For instance, when at least two pinholes are provided on a same axial position, it can be used to increase the sensitivity of the optical sensing system. For instance, indicia are provided circumferentially around a consumable article, hence the indicia may have the same coded information on two opposing side. The at least two pinholes provided opposite to each other allow two identical images to be formed on the image planes and subsequently detected by the image detector(s). The information from the two images can be processed and compared to ensure that the information is correctly read.

According to embodiments, an array of pinholes is provided extending in a direction parallel to the cavity axis. This array of pinholes may contain pinholes ranging from two to ten, the pinholes in the array of pinholes may be provided close to each other, and the images formed on the image plane may be at least partially overlapped or may not be overlapped with each other.

According to embodiments, the images provided to the image plane detectable by the image detector may be partially overlapped. When the image are partially overlapped, it has the advantage that the accuracy of the optical sensing system is increased, and a wider image can be detected.

In other embodiments, an array of pinholes is provided extending in a direction parallel to the cavity axis, wherein the pinholes in the array of pinholes form one or more slits to provide an image in planes that are orthogonal to a length of a slit. Slits allow wider image to be formed on the image plane. This allows for instance information from different parts of the indicia of the consumable article to be detected by the optical sensing system.

In other variants, one or more optical elements are provided between the pinhole and the image plane. This advantageously increases the sensitivity and accuracy of the optical sensing system of the present invention.

According to other variants, at least one field lens is provided to the optical sensing system to provide an enlarged field of view, wherein the at least one field lenses is preferably provided between the pinhole and the image detector. This has the advantage that there is less error in focusing distance when using a ‘focus and recompose’ technique in the optical sensing system.

In embodiments, the size of the pinhole is adjustable, forming a size-variable pinhole to allow a clear or more accurate image to be formed.

In embodiments, the size of the pinhole is adjustable through electromagnetic or electrostatic or through two MEMS blades, each having a half-circular aperture.

In embodiments, the light source of the optical sensing system is the heater to provide infrared light for illumination purpose.

In embodiments, the heating cavity to which a pinhole imager has been adapted is configured to allow airflow through the pinhole. This may serve to ensure that the pinhole stays optically open. The device may also be configured so that a pulse of air may be imposed through the pinhole so that deposited dust is removed from the imager, which is not possible with lenses which would require blowing air from the side, which would be extremely difficult to adaptable inside a heating cavity.

In embodiments, the pinhole may be arranged on a ring that is slidable along a direction parallel to the cavity axis.

As used herein, the term “aerosol-generating material” refers to a material capable of releasing volatile compounds upon heating, which can form an aerosol. The aerosol generated from aerosol-generating material may be visible or invisible and may include vapours (for example, fine particles of substances, which are in a gaseous state, that are ordinarily liquid or solid at room temperature) as well as gases and liquid droplets of condensed vapours.

The term “indicia” or “indicium” is defined as an element, or a structure containing information about a consumable article and is typically arranged on a surface of an article. The surface may be an outer or an inner surface of an article such as a surface pertaining to a wrapper of the article. An indicium may be imbedded inside the article. Also, more than one indicium may be arranged to or inside said article.

As used herein the term “pinhole” is to be understood broadly. It may refer to a pinhole aperture as well as any aperture that is very small in at least one dimension. As such, a thin slit having a length that is much greater than its width is also considered as a “pinhole”. Pinholes may be simple circular apertures or non-symmetric apertures or non-circular apertures. A “pinhole” may be a thin slit having a variable width along its length, but that width is always smaller than said length. Typical dimensions of the diameter of a pinhole or the width of a slit is between 1 μm-500 μm, preferably between 10 μm and 100 μm. Possibly the diameter of a pinhole or the width of a slit may be greater than 500 μm, for example 1 mm. The diameter of a pinhole or the width of a slit depends on the projection distance that is required. The greater the projection distance, the greater the aperture of the pinhole or slit may be. The optical system comprising a pinhole is effectively a light-proof box with a small hole in one side. Light from a scene passes through the aperture and projects an inverted image on the opposite side of the box, which is known as the camera obscura effect. The advantages of pinholes are their depth of focus. Everything in an image taken by a pinhole in an optical sensing system are in focus according to a relation between the distance of the object to the pinhole and the distance of the pinhole to the image plane. A pinhole system is very simple, easy to make and to use. Ideally, the pinhole is provided having a typical aperture of between about 20 μm and 200 μm, more preferably between about 25 μm and 100 μm such that a sharp and a clear image can be formed on the image plane to be detected by the image detector of the optical sensing system.

The “focal length” of a pinhole of an optical sensing system is the distance from the hole to where the image plane is. For instance, a 0.3 mm chemically etched pinhole may provide an approximate aperture of f/2 to f/100, depending on the involved distances, and a magnetic locking shutter may further be provided to allow for controlled exposures. The shutter rotates either clockwise or counterclockwise for right or left-handed operation.

By “about” or “substantially” or “approximately” in relation to a given numerical value, it is meant to include numerical values within 10% of the specified value. All values given in the present disclosure are to be understood to be complemented by the word “about” unless it is clear to the contrary from the context.

The indefinite article “a” or “an” does not exclude a plurality, thus should be treated broadly. For instance, the imaging may be realized by an optical system that has an object distance a of an indicium to a focusing system that is smaller than the image distance b between the focusing system and the image plane, i.e., baa wherein a and b are related by 1/f=1/a+1/b, f being the focal length of the focusing system of the optical reader of the device. It is generally understood that the image size must not necessarily be equal to the size of the detector that is used to detect the image. The detector may have, in at least one cross section, a size that is smaller or greater than the produced image.

### BRIEF DESCRIPTION OF THE DRAWINGS

FIG. 1a shows a schematic representation of a first embodiment of the present invention, comprising a single pinhole imager.

FIG. 1b shows an enlarged view of the first embodiment as shown in FIG. 1a.

FIG. 2 shows a schematic representation a second embodiment of the present invention, comprising two pinhole imagers provided opposite to each other.

FIG. 3 shows a schematic representation of a third embodiment of the present invention, comprising an array of pinholes.

FIG. 4 shows a schematic representation of a fourth embodiment of the present invention, comprising a single slit imager.

FIG. 5 shows a schematic representation of a fifth embodiment of the present invention, comprising an enlarged field of view pinhole imager.

FIG. 6 shows a schematic representation of a sixth embodiment of the present invention, comprising a lens.

FIG. 7 illustrates airflow through a pinhole or slit in the embodiment of FIG. 1.

FIG. 8 illustrates an aerosol-generating article with a code longitudinally arranged on an outer surface.

FIG. 9 shows the formation of an image of the code provided on the aerosol-generating article of FIG. 8 through a pinhole provided to a cavity of a smoking device according to the invention, the image plane being a curved plane and the imaging being realized in the direction parallel to a longitudinal axis X-X.

FIG. 10 illustrates a cavity of a smoking device according to the invention to which a movable slit is provided in a movable ring configured to slide along the outer surface of the cavity.

FIG. 11 illustrates an embodiment of a device comprising a 2D array of pinholes that allows to provide an overlap of images, each pinhole providing an image.

### DETAILED DESCRIPTION OF THE INVENTION

The present invention will be described with respect to particular embodiments and with reference to the appended drawings, but the invention is not limited thereto. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

The invention will be described in the following examples in relation to aerosol-generating consumable articles 1 comprising a tobacco-containing charge of aerosol-generating material but the scope of the invention shall not be construed as limited only to the discussed tobacco-based consumable articles but shall encompass any aerosol-generating consumable articles, such as smoking articles, heat-not-burn articles, e-liquid cartridges and cartomizers, which comprises an aerosol-generating substrate capable to generate an inhalable aerosol upon heating. Aerosol-generating consumable articles 1 may or may not have a symmetry axis and may have any form or shape, such as an elongated, cylindrical shape, or a spherical shape, or the form of a beam.

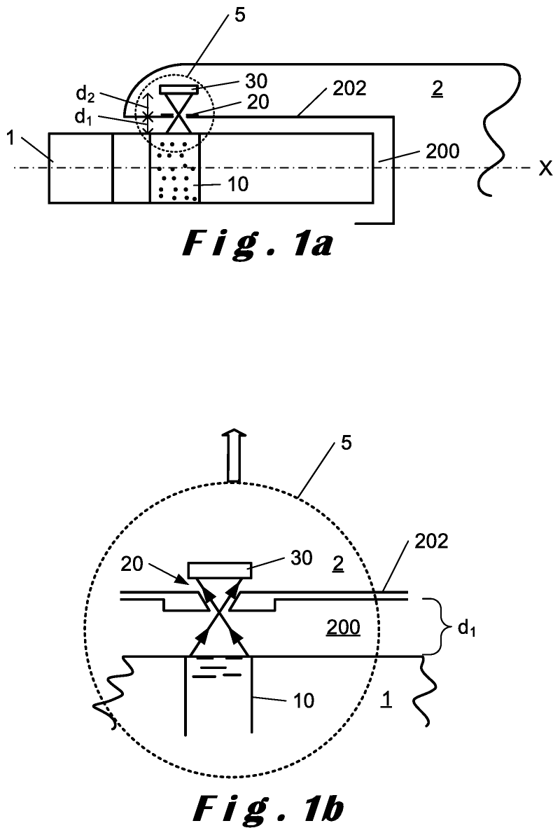

As represented in FIGS. 1 to 6, aerosol-generating articles 1 may comprise at least a first portion comprising an indicium p arranged on an outer surface and a second portion attached to the first portion, which the second portion may form a mouthpiece for a user to inhale an aerosol generated upon heating of the first portion after insertion of the consumable article 1 (e.g., aerosol-generating consumable article) in a heating cavity of an aerosol-generating device 2. The article 1 comprises a further portion which may not comprise an indicium 10. The indicium 10 may be arranged to one or both of the lateral sides of said further portion.

FIG. 1a shows a smoking device 2 (e.g., an aerosol-generating device) comprising with a cavity 200 for receiving, in use, a consumable article 1 inserted in said cavity 200. The cavity is a receiving portion of the smoking device 2 where at least a part of the consumable article 1 can be inserted. The walls of the cavity 200 may be substantially parallel to the cavity axis. Nevertheless, even when a consumable article 1 has been inserted in said cavity, a tiny gap 200 may still exist between the inserted consumable article 1 and the cavity walls, as illustrated by the FIG. 1a. An optical sensing system 5, which is capable of detecting indicia arranged on consumable article 1 inserted in the cavity is further arranged in the smoking device 2 as further described in detail herein.

FIG. 1a shows a first embodiment, wherein a pinhole 20 is provided to the optical sensing system 5 of the smoking device 2. The pinhole 20 can be provided to a wall of the receiving portion 202 of the cavity 200. A gap 200 between the consumable article 1 and the internal wall of the receiving portion 202, which may be created by internal projections arranged in the cavity 200, such as fins, ribs, or the like, not shown in the drawings for sake of clarity. The optical sensing system 5 comprises a pinhole 20 and an image detector 30 which is placed in a chosen position as the image plane. Of course, it is also foreseen that the image detector 30 need not be placed on the image plane.

As visible in FIG. 1a, the distance between the image detector 30 and the pinhole 20 is represented with d₂ while the distance between the pinhole and the indicium 10 of a consumable article 1 is represented with d₁. When the consumable article 1 comprising an indicium 10 is inserted into the receiving portion 202 of the smoking device 2, an image of the indicium 10 can be formed on the image plan through the pinhole 20 and subsequently detected by the image detector 30 of the optical sensing system 5. A light source such as a LED can be provided in proximity to the pinhole 20 to provide light towards the indicium 10. The image detector 30 may be placed anywhere in the smoking device 2 as far as the image formed on the image plane can be transferred and/or detected by the image detector 30.

FIG. 1a illustrates one of the simplest pinhole imaging systems where a single pinhole 20 is provided to the optical sensing system 5. The portion of the consumable article 1 provided with an indicium 10 may be an image indicium or a coded indicium such as a printed code realized by ink. The indicium 10 may be a typical barcode or may be an arrangement of a plurality of 1D or 2D dots.

The use of a pinhole 20 in the optical sensing system 5 has the advantage that no lenses or curved mirrors are needed to image the indicium 10 arranged on an outer surface of the consumable article 1 when inserted in the receiving portion 202 of the cavity 200. As illustrated in FIG. 1, when the object to be imaged is an indicium 10, light is projected by pure geometric effects and the magnification factor is determined by the involved distances: M=d₂/d₁, wherein M may be smaller or equal to 1 (usually) or may be bigger than 1. In some cases, the use of pinholes may be suitable to environments where sufficient light source can be provided.

It is acknowledged herein that pinholes may provide darker images than those provided by lenses or mirrors (because of the small aperture of the pinhole). These images are however usually sharp for given values of distance d₁ and d₂. This is due to the fact that in a pinhole-based optical sensing system, light source only comes from a single direction, to the contrary of lenses and curved mirrors, which have a broader field of view.

Several parameters are important to a pinhole imaging system, such as: (a) the distances from an object to the pinhole and from the pinhole to an image plane; (b) the aperture(s) of the pinhole, which typically may be between for example about 20 and 500 microns; (c) the quality of the borders of the pinholes (that are in principle round-shaped pinholes), (d) diffraction effects, which are related to the wavelength of the light source used for imaging an object through the pinhole and the roughness of the borders of the pinhole aperture(s).

Diffraction effects and defects at borders of the pinhole aperture(s) may provide blurry or unclear images. Therefore, to guarantee high quality pinhole formation the at least one pinhole (for example pinhole apertures of about 20-500 μm) of the optical sensing system may be made of a chrome mask. A chrome mask may have two main types of base materials: soda lime glass which is comparatively inexpensive and/or synthetic quartz which has low thermal expansion and high optical transmittance. The chromium layer may be realized on any transparent surface, ideally of glass or Al₂O₃(Corundum or doped Sapphire e.g. with titanium or iron).

As for the light source which is required to image an indicium 10 with the optical sensing system 5 arranged in smoking device 2, pulsed light sources such as a pulsed LED or pulsed lasers (UV, visible, infrared) may be used. Furthermore, an image detector 30 may be configured to perform synchronous detections so that very low average light intensities may be used and is still sufficient for the image detector to detect the image. It is sufficient that that peak power of the pulsed light is sufficiently high.

To improve optical performance of the pinhole optical sensing system 5, in particular against diffraction effects, pinholes solutions may be provided in layers or substrates made of silicon (Si) or hard materials (SiO2, quartz, synthetic diamond, Al₂O₃). Salt windows may also be used as a substrate, as they have a very wide spectral transmission. Salt windows or layers made from any combination of the first and last column of the periodic table (such as NaCl, NaBr, KCl, Kl, CsBr, CsCl, CsI and etc.) are commercially available and may have the best transmission in the mid and far infrared and have the largest spectral transparency, allowing to transmit as well blue light as mid/far infrared light.

A preferred choices to make pinholes is probably to manufacture them in a chromium layer deposited on a SiO₂ window (or Si for wavelengths λ larger than 1.5 μm as Si is transparent above 1500 nm).

A pinhole optical imaging system 5 as considered herein is thus a low cost, but effective imaging solution for reading indicia on aerosol-generating articles 1, in particular when arranged close to a very hot surface such as that of a smoking device cavity 200 as considered in the invention. A pinhole imaging system is especially suitable for low resolution indicia such as printed barcodes.

FIG. 1b shows a closed-up view of the optical sensing system 5 from FIG. 1a provided with a pinhole 20. The indicium 10 on the consumable article 1 may preferably be provided on a wrapper thereof. The term “wrapper” is defined broadly as any structure or layer that protects and contains for example the charge of smoking material, and which allows to handle that material. The wrapper has an inner surface that may be in contact with the smoking material and has an outer surface away from the smoking material. The wrapper may preferably comprise a cellulose based material such as paper but may also be made of a biodegradable polymer or may be made of glass or a ceramic. The wrapper may be a porous material and may have a smooth or rough outer surface and may be a flexible material or a hard material. A wrapper may constitute an optical opaque or partially transparent optical layer. In the case of paper, a wrapper is partially transparent in the visible and in the infrared and may be partially transparent in the UV. A wrapper may comprise apertures. Said indicium 10 may arrange at least partially in front of the at least one aperture provided on the surface of the wrapper.

The indicium 10 may also be arranged according to a 2D or 3D arrangement of structures and may have any shape such as a square, or a rectangular shaped band. Preferably said band comprises an array of redundant code elements that are arranged on a complete circumference of said article 1. The term “redundant” herein means that the indicium 10 may comprise an array of repetitive code elements, or blocks of code elements, and may be read by a fixed optical magnification reader, independent of the position of the article 1, such as the angular position, relative to the optical magnification reader system. This may be realized for example, without limitation, by an indicium 10 that is constituted by an array of reflective or diffractive structure, an array of absorptive structures, or an array of resonating waveguides or a combination of them.

Apart from anti-counterfeit properties it is desired that the indicium 10 may also contain information of specific parameters that should be used by the smoking device 2 such as the ideal temperature range, or the heating profile in function of time, or parameters which allow to provide to the smoker different smoking tastes or intensities.

FIG. 2 shows another embodiment of a smoking device 2, where two pinholes 20, 22 are provided to opposite walls of the receiving portion 202 of the smoking device 2. As the pinholes 20, 22 are not provided on the same axial and/or longitudinal position, images 51, 52 having information from different parts of the indicium 10 of the consumable article 1 can be formed on the image plane and subsequently detected by the respective image detector 30, 32. In other words, the first pinhole 20 allows a first part of the indicium 10 to form a first image 51 on a first image plane while the second pinhole 22 allows a second part of the indicium to form a second image 52 on a second image plane. These two images 51, 52 are subsequently detected by the image detectors 30, 32 of the optical sensing system. The image detectors, are placed in the first and second image planes of the images 51, 52. Otherwise, the pinholes 20, 22 according to this embodiment may be similar to the first embodiment, for instance the d₁ is identical to the distance d₃, and d₃ is identical to d₄. In this embodiment, at least two identical pinhole images are used. FIG. 2 shows a layer Won which the second pinhole 22 is formed on said layer W. The layer W may be a thin glass plate for example. In variants, both pinholes may be formed as an aperture in for example a Silicon (Si) chip or both may be formed by a coating on a transparent plate W. Nevertheless, it is foreseen that two different pinhole imagers may also be provided, wherein each pinhole imager S1, S2 providing a different magnification factor M1, M2.

In all embodiments, the magnification factor M1, M2 is preferably greater than 1 but may be smaller than 1 or equal to 1.

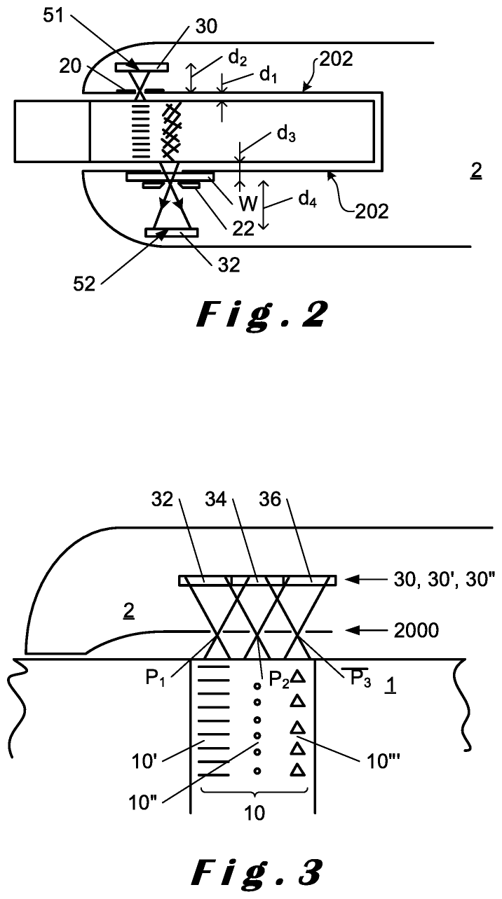

FIG. 3 shows a further embodiment where a plurality of pinholes 20, 20′, 20″ are provided to the same wall of the receiving portion 202 but are arranged on different longitudinal positions. In this embodiment, the pinholes 20, 20′, 20″ are arranged close to each other, wherein images P1, P2, P3 which pass through the pinholes 20, 20′, 20″, respectively, formed on the image plane are partially overlapped with each other such that information 10′, 10″, 10″ from different parts of the indicium 10 are reflected on the image plane, and subsequently detected by the image detector 32, 34, 36 of the optical sensing system.

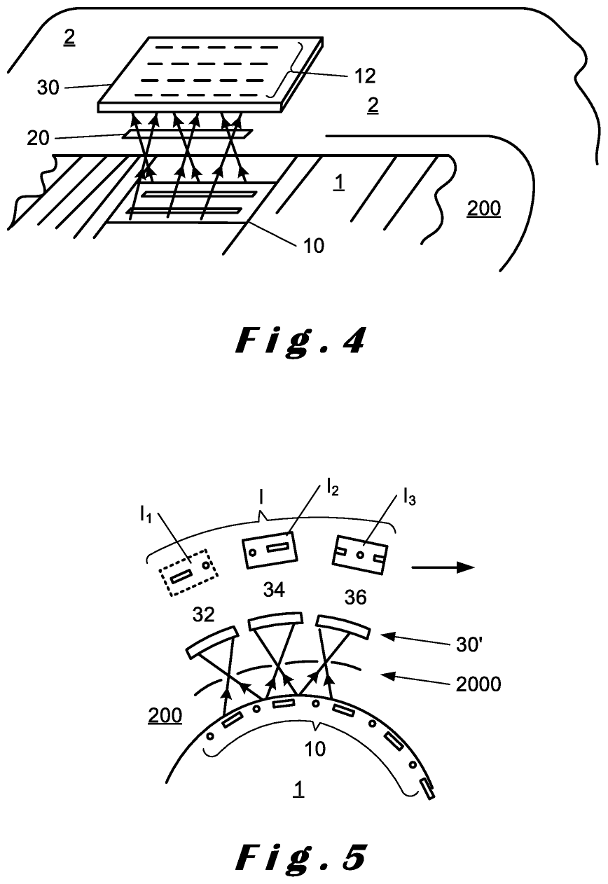

FIG. 4 shows a further embodiment where the pinhole 20 is formed in form of a slit, wherein the slit is a rectangular shape, thus allowing a broader horizon. It can be foreseen that the slit is provided with a plurality of connected pinholes. Similar to the pinhole, a slit allows an image to be produced in an image plane that is orthogonal to the length of a slit. As in the previous embodiments, once the consumable article 1 is inserted in the receiving portion of the smoking device 2, the indicium 10 is placed facing directly to the pinhole 20. Similar to the embodiment described in the FIG. 3, this embodiment is useful such that information from different parts of indicium 10 can be reflected on the image plan and be detected by the image detector 30. In this example, the slits may serve as an alternative to cylindrical lenses. FIG. 4 illustrates the formation of the image 12 of an indicium 10 comprising a plurality of arrays in form of linear-coded.

FIG. 5 shows an embodiment comprising a pinhole array 2000 so that an indicium 10 comprising an array of indicium elements are imaged on an image detector array 30′ comprising a plurality of image detectors 32, 34, 36 By using a curved shape of the substrate or support that comprises the pinhole array 2000, it is possible to provide images I1-I3 on a curved image plane to which the detector array 30′ is arranged. Such embodiment allows to image indicia arranged over a certain length at a periphery of a curved shaped smoking article 1, such as a cylindrical shaped smoking article 1.

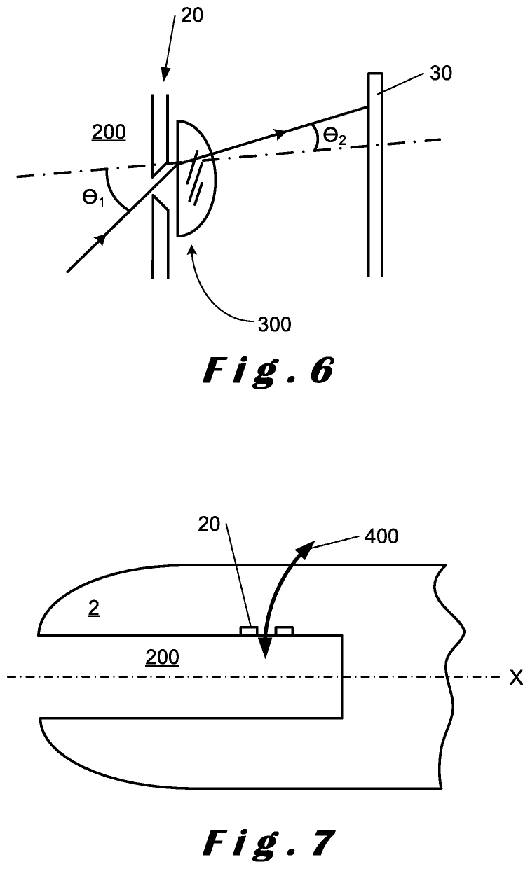

To this end, it is disclosed that the according to one further embodiment, the field of view of a pinhole imaging system can be enlarged by placing a field lens 300 behind the pinhole 20, as illustrated in the FIG. 6. It is noteworthy that the field lens 300 does not produce an image but merely deviates the rays of light, which is not to be equated as focusing micro lenses.

All the embodiments described herein may be adapted to transmit also an illumination beam that is provided by a light source arranged in the optical sensing system 5 or as a separate component in the smoking device 2, for instance, provided to the side away of an indicium 10. This may be realized by using for example a beam splitter or a semi-transparent mirror. Arranging an illumination beam in optical systems, such as a microscope, is well known and is not further described herein.

The optical sensing system 5 may comprise an optical projection system having a magnification factor greater than 1, and at least one image detector. The image detector may be a single detector, a detector array, a detector system comprising optical elements and electronics, or may comprise an imager and/or or a miniaturized spectrometer.

The light source or illuminating system can be any source that may provide a light beam, preferably in the range of UV (ultraviolet), visible or infrared (IR) light. A light source may be for example a LED or a semiconductor laser. The light source must not be necessarily a power-driven light source, and thus may for example be a part or an area of a heater or a hot part of the aerosol generating device and/or or the consumable article that provides a beam of infrared light.

Upon illumination by the light source, the indicium 10 of a consumable article 1 will generate a projected light beam, which can be a reflected, transmitted, or a diffracted light beam. The projected light beam may provide, after reflection or refraction or diffraction by a first focusing element, at least one secondary light beam that is transmitted directly onto an image detector 30, or by using for example single or compound reflective, refractive or diffractive elements, beam splitters or a combination of such elements.

Said projected light beam is then received on an image detecting system, which is also defined as an image detector 30 as used herein, which includes means to convert optical information provided by at least one indicium 10 of a consumable article into an electrical signal or data that may be used to recognize the article and/or identify information related to the parameters of the smoking device 2, for example parameters that should be used, in operation of the smoking device 2, for said consumable article 1. An optical sensing system 30 may comprise a single detector or a detector array or may comprise a vision system. The optical sensing system 30 may also comprise colour filters or a miniaturised spectrometer.

In some variants it may be necessary to provide a projection system having an important magnification factor, for example a factor of 10, or more than 20 or more than 50. In some instances, due to the lack of space in a typical aerosol generating device, the optical path may be deviated by using at least one secondary deflection mirror, which may be a flat or a curved mirror. In variants, not illustrated herein, the optical magnification system may be based on a catadioptric configuration. This allows to provide a compact optical system while at the same time providing a long projection length and thus a high magnification factor.

Realizing arrays of micro holes on metal layers on transparent layers is a widely available technology. Moreover, very precise micro-structured apertures may also be realized in silicon (Si) by MEMS technologies. In MEMS materials the apertures may have a V-Shape. Apertures may be realized on small field lenses as illustrated in the FIG. 6.

The dimension of the pinhole 20, 20′, 20″ and its distance d₁ to the indicium and its distance d₂ to the image detector 30 has to be determined in function of the available space and the needed amplification or reduction of size of the image, which are determined only by the ratio of (distance of pinhole-detector)/(distance of indicium-pinhole). The size of the aperture of the pinhole should be as small as possible but there is a trade-off to be found between the available intensity and diffraction effects and also the required resolution of the image of the indicium. For example, the greater the “projection distance”, the greater will be the magnification factor M and the resolution. Smaller projection distances give a wider view but a smaller resolution.

According to some embodiments, the optical sensing system comprises at least one pinhole and an image detector, and the pinhole, or width of the slit, may be provided in the following conditions:
Substrate: Fused silica, B270, Borofloat, D263,
Thickness: 0.3 mm to 10 mm,
Coating material: Chrome, IMTBC,
Pinhole diameter: typically greater than 1 μm,
Pinhole diameter tolerance: 0.5 μm,
Position accuracy: Less than 0.5 μm.

In some further embodiments, the optical sensing system comprising one or more pinholes may be provided in a more sophisticated manner. For instance, pinhole arrays and optionally spatial filters may be used for spatial filtering and act as virtual point light sources in many optical systems. A pinhole (or also known as a pinhole aperture) limits the numerical aperture (NA), defining the divergence of the transmitted light beam, and blocks larger angles.

In some further examples, Nipkow discs which are used in confocal microscopy may also be provided to the optical sensing system according to the present invention. As part of the lighting system, they are also found in fluorescence microscopy and material testing. The elements feature pinholes, which are arranged in a ‘Nipkow pattern’ on a planar substrate ensures that there are no defects during the micro-structuring of the black chrome coating. This is because even the smallest of defects in the size of a pinhole diameter will lead to streaking in the image, thereby rendering the disc unusable.

In other example, the distance d₂ may be between 1 mm and 10 mm or between 2 mm and 20 mm, without limitation. The distance d₁ which is between the indicium 10 and the pinhole may be between 0.5 mm and 5 mm or between 1 mm and 3 mm, also without any limitation. The choice of d₁, d₂ and the pinhole type and its diameter depends on each particular geometrical arrangement according to the particular design of the available space in the smoking device so that imaging of indicia of smoking articles may be imaged. In certain variants, a small mirror may be arranged in between the pinhole and the detector, or a microprism may be used to deflect the light to the image detector 30.

In order to achieve the sharpest image, the pinhole ideally should be of the optimum size, perfectly round and preferably be made from the thinnest material. Nevertheless, sharpness alone does not always have to be the most important requirement. Images from a pinhole may be a little less sharp and sometimes a certain amount of blur can, in itself, be an attractive means of expression. The principle of the pinhole ensures that the image of a point is, in fact, a small disc. The smaller the hole, the smaller the disc and hence the sharper the image. Nevertheless, this is only true up to a point. If the hole is too small, then light is diffracted, and the image becomes less sharp. Hence, an optimum hole diameter exists for each focal length (distance from the hole to the light-sensitive material) which will create the sharpest picture. The equation of an optimal pinhole diameter may be based on the formula proposed by Lord Rayleigh, revised so that the result gives the diameter, not the radius, can be written as follows:

d=1,9√(f−l); wherein;
d—pinhole diameter;
f—focal length;
l—wavelength (usually the wavelength for yellow/green light 0.00055 mm is used).

The calculation of the optimum hole diameter or the optimum focal length can be made using any commonly known methods that is available to skilled persons. For instance, the calculation can be made using a PinholeDesigner programme.

To this end, it is disclosed that the pinhole according to the present invention can be provided as a size-variable pinhole. For instance, the pinhole size may be changed by a mechanism involving electromagnetic or electrostatic forces, such as applied by piezo elements, or any MEMS actuator based on forces (e.g. MEMS magnetic actuator). In an example, the pinhole is formed by two opposite MEMS blades that may be addressed by electrostatic addressing. In another example, each of the two MEMS blades may comprise a side with a half-circular aperture (or a half-pipe shaped on one side). The two half-circular shaped apertures form a full-circular aperture when the blades are laterally in contact with each other. The area of the aperture may be adapted by moving the two blades, thereby the pinhole size is adjustable.

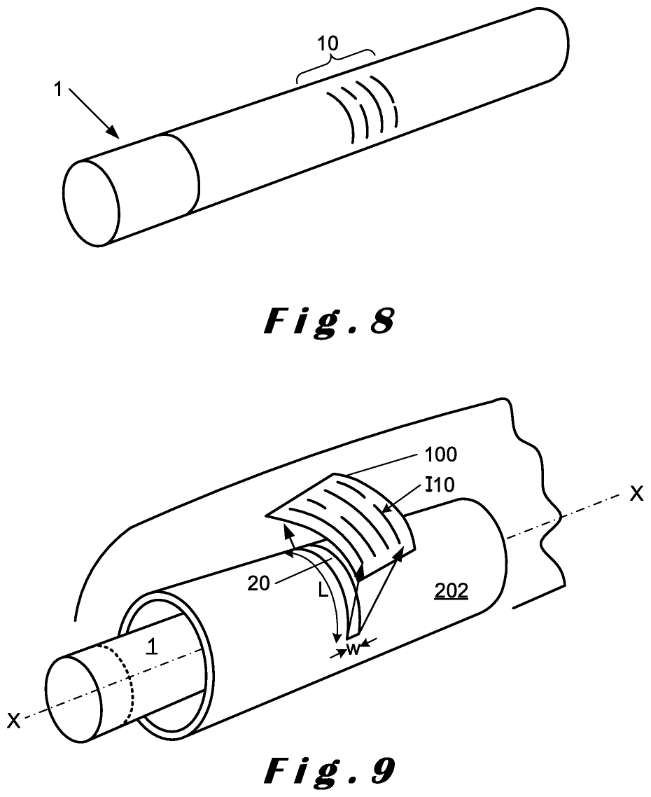

As defined before, a “pinhole” may be a long thin slit. The slit may be a straight slit or a curved slit. A slit may be used for an advantageous embodiment of a pinhole imager that is realized by realizing an aperture along a portion of the circumference of a heater element, as illustrated in FIG. 9. In such as case the pinhole arrangement is a long narrow slit 20 and behaves as a curved cylindrical lens. It would be nearly impossible to realize such a thin optical curved element by any refractive element. To, the contrary, realizing a long thin slit along a portion of a circumference of a heater element, as illustrated in FIG. 8, allows to form an image I10 of a code 10 on a curve image plane 100. If the slit 20 is realized perpendicular to the longitudinal axis x of a heater element 202 it allows to provide an image I10 in the direction of that longitudinal axis x, as illustrated in FIG. 8 Such a configuration allows to provide an image I10 of a least a portion of a code 10 that is arranged to a smoking article 1, such as the smoking article 1 represented in FIG. 8.

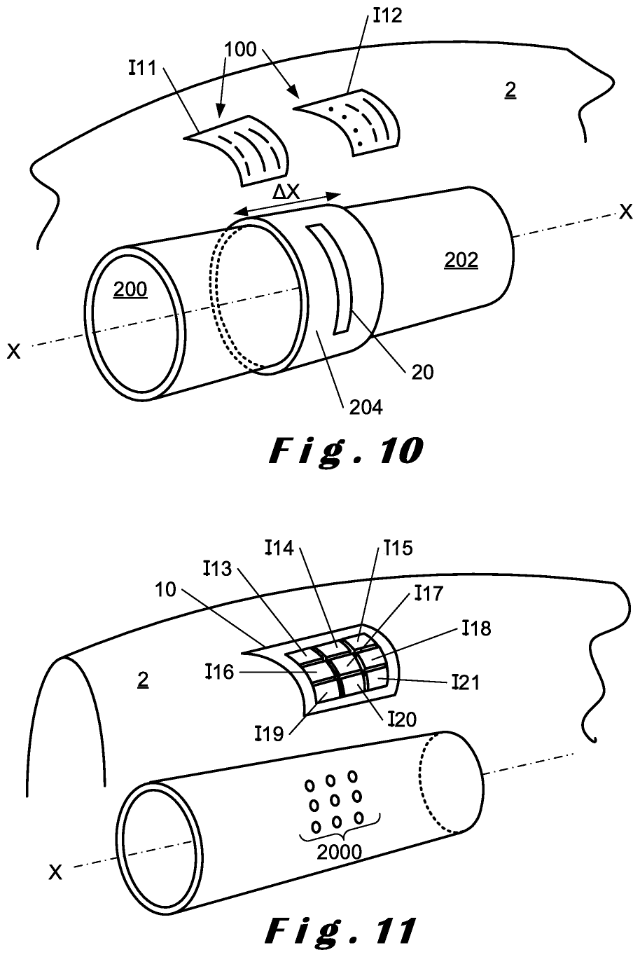

In an advantageous embodiment, a movable slit is provided to the cavity 200, as illustrated in FIG. 10. The slit is arranged in a movable ring 204 that may slide in the longitudinal x direction. By moving the slit, a succession of images I11, I12 may be provided to an imager. The advantage is that is easy to realise a slit in a ring, to the contrary of any refractive curved element.

In embodiments, a heating cavity 200 to which a pinhole imager has been adapted by be configured to assure airflow through the pinhole. Such an embodiment, illustrated in FIG. 7 may serve to assure that the pinhole stays optically open. The device may also be configured so that a pulse of air may be imposed through the pinhole so that deposited dust is removed from the imager, which is not possible with lenses which would require blowing air from the side, which would be extremely difficult to adaptable inside a heating cavity.

In an advantageous embodiment, illustrated in FIG. 11, a 2D array of pinholes 2000 may be arranged and provide an overlap of images I13-I21, each pinhole providing an image. This allows to provide an improved device and a large field of view. By using a 2D array of pinholes, image correlation and deconvolution processing may be used to provide stitching of the overlapping images, which reduces the noise. A typical array of pinholes 2000 may cover an area as small as 3×3 mm and contain more than 10, possible my more than 50 pinholes. Such a configuration would not be possible with refractive lenses, because of the huge aberrations induced by micro lenses that are smaller than 50 μm.

1. An electrically powered smoking device configured to receive a consumable article, comprising,
a housing having a cavity, defining a cavity axis, for receiving at least partially the consumable article, and
an optical sensing system for detecting indicia on the consumable article, wherein the optical sensing system comprises at least one pinhole and an image detector, wherein the at least one pinhole allows light to form an image on an image plane, detectable by the image detector.

2. The smoking device according to claim 1, further comprising a light source.

3. The smoking device according to claim 1, wherein the at least one pinhole includes at least two pinholes positioned approximately opposite to each other such that indicia on the consumable article can be detected by the optical sensing system through the at least two pinholes.

4. The smoking device according to claim 3, wherein the at least two pinholes are provided to different axial positions and/or longitudinal positions.

5. The smoking device according to claim 3, wherein the at least two pinholes are provided to the same axial position or longitudinal position.

6. The smoking device according to claim 1, wherein the at least one pinhole includes an array of pinholes provided parallel to the cavity axis.

7. The smoking device according to claim 6, wherein images provided to the image plane detectable by the image detector are at least partially overlapped.

8. The smoking device according to claim 1, wherein the at least one pinhole includes an array of pinholes provided parallel to the cavity axis, wherein the array of pinholes form one or more slits to provide an image in planes that are orthogonal to a length of a slit of the one or more slits.

9. The smoking device according to claim 1, wherein one or more optical elements are provided in between one of the at least one pinhole and the image plane.

10. The smoking device according to claim 1, wherein the optical sensing system includes one or more field lenses to provide an enlarged field of view.

11. The smoking device according to claim 1, wherein the optical sensing system further comprises an integrated heater to provide a light source for illumination.

12. The smoking device according to claim 1, wherein a size of each of the at least one pinhole is adjustable, forming a size-variable pinhole.

13. The smoking device according to claim 12, wherein the size of each of the at least one pinhole is adjustable through electromagnetic or electrostatic forces or through two MEMS blades, each having a half-circular aperture.

14. The smoking device according to claim 1, wherein said at least one pinhole is arranged on a ring that is slidable longitudinally in the cavity.

15. The smoking device according to claim 2, wherein the light source is positioned on a side of the smoking device facing the consumable article when the consumable article is at least partially received in the cavity.

16. The smoking device according to claim 6, wherein images provided to the image plane detectable by the image detector are not overlapped.

17. The smoking device according to claim 10, wherein the one or more field lenses are provided in between the at least one pinhole and the image detector.
